(19) United States
(12) Patent Application Publication
(10) Pub. No.: US 2021/0348989 A1
(43) Pub. Date: Nov. 11, 2021

(54) METHOD FOR PREPARING TEST SAMPLES FOR SEMICONDUCTOR DEVICES

(71) Applicant: SHANGHAI HUALI INTEGRATED CIRCUIT CORPORATION, Shanghai (CN)

(72) Inventors: Qiang CHEN, Shanghai (CN); Sheng Chen, Shanghai (CN); Jinde Gao, Shanghai (CN)

(21) Appl. No.: 17/185,736

(22) Filed: Feb. 25, 2021

(30) Foreign Application Priority Data
May 8, 2020 (CN) 202010382624.X

(51) Int. Cl. G01N 1/28; G01N 23/04

(52) U.S. Cl. CPC G01N 1/286; G01N 23/04

(57) ABSTRACT

The present application provides a method for preparing a test sample of a target semiconductor device, an imaged lateral surface of the sheet test sample exposes a first cross section of a target semiconductor device in the vertical direction; a protective layer is deposited on both sides of the sheet test sample the where the target semiconductor device is located, to longitudinally coat the sheet test sample; and the sheet test sample is longitudinally cut to obtain a columnar test sample. The present application discloses a method to an prepare an ultra-thin sample and perform TEM cross section imaging and analysis on the sample from two directions, thereby improving efficiency in analysis of complex structures and complex defects.

### CROSS-REFERENCES TO RELATED APPLICATIONS

This application claims priority to Chinese patent application No. CN202010382624.X filed on May 8, 2020 at CNIPA, and entitled “METHOD FOR PREPARING TEST SAMPLES FOR SEMICONDUCTOR DEVICES”, the disclosure of which is incorporated herein by reference in entirety.

### TECHNICAL FIELD

The present application relates to the field of semiconductor integrated circuits, in particular to a method for preparing a TEM sample for semiconductor device test and analysis.

### BACKGROUND

Since the early days when Dr. Jack Kilby of Texas Instruments invented the integrated circuit (IC), scientists and engineers have made numerous inventions and improvements in the aspects of semiconductor devices and processes. The sizes of semiconductor IC device dimensions have shrank many folds in the past 50 years, resulting in continuous increase in IC processor speed and continuous reduction in power consumption. For decades, the development of IC chip industry has generally followed the Moore's Law. The Moore's Law describes a rule that the number of transistors in a dense integrated circuit doubles approximately every two years. Currently, the chip making process has developed beyond the node below 20 nm, and some even are working on the 14-nm process. A reference is provided herein, wherein the diameter of a free silicon atom is about 0.2 nm, the lattice constant of silicon crystal is 0.5 nm, so the distance between two independent components manufactured by means of the 20-nm process is only about the sum of the diameters of a hundred silicon atoms.

Therefore, manufacturing of semiconductor chip devices has becomes increasingly challenging and has been developing towards the feasible physical limit. In order to ensure the quality of semiconductor chips, test samples are prepared and analyzed, to determine causes of defects and other information of the chip compared with the process specification.

Transmission Electron Microscope (TEM) has nanometer level high resolution, and has been one of the most commonly used imaging tools for advanced integrated circuis. Generally speaking, a transmission electron microscope requires very thin TEM samples in the order of only a few dozens of nanometers. The TEM samples are more likely to result in accurate structure imaging if they possess small thickness around one hundred nanometers.

Among the more advanced IP chip technologies, devices having a complex 3D structure, such as fin field-effect transistors (FinFETs), have emerged. For FinFET devices, it is often necessary to analyze the structures from at least two cross sectional directions. In addition, defect analysis in most chips also requires the analysis of chip samples in at least two directions, in order to determine causes of the defects from multiple process steps where defects might have occurred.

Currently the existing method for preparing a TEM sample utilizes the Focused Ion Beam (FIB) to cut a chip test sample of into ultra-thin sheet TEM samples. After one such the ultra-thin TEM sample is prepared, one cross section of the structure that is to be tested in one direction of the IC chip is exposed, while the cross sections of the structure in other directions of the same IC chip cannot be imaged in the same run.

In view of the above, there is an urgent need for a method for preparing a TEM sample, in which ultra-thin sample preparation can be performed in two directions for the same sample, so that TEM analysis of the target sample can be performed in two directions to obtain its structural information in two directions, thereby facilitating the analysis of a complex structure or a complex defect.

### BRIEF SUMMARY

A brief overview of one or more embodiments is given below to provide a basic understanding of these aspects. The overview is not an exhaustive disclosure of all of the aspects conceived, and is neither intended to identify key or decisive elements of all of the aspects nor is it attempts to define the scope of any or all of the aspects. The purpose is to present concepts of one or more embodiments in a concise form as a prelude to the more detailed description provided later.

The disclosure provides a method for preparing a test sample of a target semiconductor device, comprising steps of:

providing a sheet test sample, wherein the sheet test sample has a first lateral surface and a second lateral surface, wherein the first lateral surface contains the target semiconductor device, wherein the first lateral surface of the sheet test sample exposes a first cross section of the target semiconductor device in a vertical direction;

forming a protective layer on the first and second lateral surfaces of the sheet test sample, to longitudinally coat the sheet test sample; and

cutting longitudinally the sheet test sample, to obtain a columnar test sample, wherein a longitudinal surface of columnar test sample exposes a second cross section of the target semiconductor device in the vertical direction, wherein the second cross section is perpendicular to the first cross section.

In some cases, forming the protective layer further comprises steps of:

providing a silicon wafer having a trench;

placing the sheet test sample vertically into the trench; and

depositing longitudinally a protective layer in the trench to coat the first and second lateral surfaces of the sheet test sample.

In some cases, the protective layer is made of metal platinum (Pt) or metal tungsten (W).

In some cases, the longitudinal cutting is performed by a focused ion beam.

In some cases, providing the sheet test sample further comprises: cutting a wafer on which the target semiconductor device is located with a focused ion beam, to obtain the sheet test sample.

In some cases, a longitudinal thickness of the sheet test sample is less than 100 nanometers.

In some cases, a lateral thickness of the columnar test sample is less than 100 nanometers.

In some cases, a longitudinal thickness of the columnar test sample is less than 100 nanometers.

In some cases, the first lateral surface of the sheet test sample is imaged with a transmission electron microscope; and/or the longitudinal surface of the columnar test sample is imaged with a transmission electron microscope.

In some cases, the semiconductor device is a fin field-effect transistor.

According to the method for preparing a test sample of a semiconductor device provided by the present application, ultra-thin sample preparation can be performed in two directions for the semiconductor device to be tested, so that analysis of the prepared test sample can be performed in two directions by means of a transmission electron microscope to obtain structural information in two directions of the semiconductor device, thereby improving the structural analysis of a semiconductor device having a complex structure or root cause analysis of a complex defect.

### BRIEF DESCRIPTION OF THE DRAWINGS

By reviewing the detailed description of the embodiments of the present disclosure with reference to the following drawings, the above-mentioned features and advantages of the present application can be better understood. In the drawings, various components are not necessarily drawn to scale, and components with similar related characteristics or features may have the same or similar reference numerals.

FIG. 1 illustrates a flowchart of the sample preparation method according to an embodiment of the present disclosure.

FIG. 2 illustrates a flowchart of forming a protective layer according to an embodiment of the present disclosure.

FIG. 3A illustrates a schematic diagram of a sheet test sample according to an embodiment of the present disclosure.

FIG. 3B shows the TEM image of the sheet test sample according to an embodiment of the present disclosure.

FIG. 4 illustrates the silicon wafer base for the sample according to an embodiment of the present disclosure.

FIG. 5 illustrates picking up the sheet test sample according to an embodiment of the present disclosure.

FIG. 6A illustrates placing the sheet test sample in a trench according to an embodiment of the present disclosure.

FIG. 6B shows the TEM image of placing the sheet test sample in the trench according to an embodiment of the present disclosure.

FIG. 7A illustrates forming the protective layer according to an embodiment of the present disclosure.

FIG. 7B shows the TEM image of forming the protective layer according to an embodiment of the present disclosure.

FIG. 8A illustrates forming the protective layer in FIG. 7A in the XY plane.

FIG. 8B shows the TEM image of forming the protective layer in FIG. 7A in the XY plane.

FIG. 9 illustrates a schematic diagram of forming a columnar test sample in the XY plane.

FIG. 10A illustrates a schematic diagram of the columnar test sample in a YZ plane.

FIG. 10B shows the TEM image of the columnar test sample in the YZ plane.

FIG. 10C shows the TEM image of the columnar test sample in FIG. 10B under high magnification.

FIGS. 11-13 show TEM images from test samples prepared by other methods according to some embodiments of the present disclosure.

### REFERENCE NUMERALS

100, 110 first sheet test sample
120 second sheet test sample
30 columnar test sample
200 stage
210 nanomanipulator
300 silicon wafer
310 trench
400, 410, 420 protective layer
910 first section of the semiconductor device to be tested
920 second section of the semiconductor device to be tested

### DETAILED DESCRIPTION OF THE DISCLOSURE

The present application is described in detail below with reference to the drawings and specific embodiments. It should be noted that the following aspects described with reference to the drawings and specific embodiments are merely intended for description and should not be construed as limiting the protection scope of the present application.

The application relates to the field of semiconductor device tests, in particular to a method for preparing a test sample of a semiconductor device. According to the method for preparing a test sample of a semiconductor device provided by the present application, ultra-thin sample preparation can be performed in two directions for the semiconductor device to be tested, so that analysis of the prepared test sample can be performed in two directions by means of a transmission electron microscope to obtain structural information in two directions of the target device structure, thereby providing great help to the structural analysis of a semiconductor device having a complex structure or root cause analysis of a complex defect.

The following description is provided to enable a person skilled in the art to implement and use the present application and apply it into specific application scenarios. Various modifications and various uses in different applications will obvious to a person skilled in the art, and the general principle defined herein can be applied to embodiments in a relatively wide range. Therefore, the present application is not limited to the embodiments given herein, but should be granted the broadest scope consistent with the principle and novel feature disclosed herein.

In the following detailed description, many specific details are set forth to provide a more thorough understanding of the present application. However, it is obvious to a person skilled in the art that the practice of the present application may not necessarily be limited to these specific details. In other words, well-known structures and devices are shown in the form of block diagrams rater than in details, to avoid obscuring the present application.

Readers should pay attention to all files and documents submitted along with this specification and open to the public for consulting this specification, and the contents of all of the files and documents are incorporated hereinto by reference. Unless otherwise directly stated, all the features disclosed in this specification (including any appended claims, abstract, and drawings) can be replaced by alternative features for achieving the same, equivalent, or similar purpose. Therefore, unless otherwise expressly stated, each feature disclosed is merely an example of a set of equivalent or similar features.

It should be noted that when used, the signs left, right, front, rear, top, bottom, front, back, clockwise, and counterclockwise are only used for the purpose of convenience, and do not imply any specific direction. In fact, they are used to reflect a relative position and/or orientation between various parts of an object.

As used herein, the terms “over”, “under”, “between”, and “on” refer to a relative position of one layer relative to another layer. Likewise, for example, a layer deposited or placed over or under another layer may directly contact the other layer or may be separated from the other layer by one or more intermediate layers. Furthermore, a layer deposited or placed between layers may directly contact the layers or may be separated from the layers by one or more intermediate layers. In contrast, a first layer “on” a second layer is in contact with the second layer. In addition, a relative position of one layer relative to the other layers is provided (assuming that deposition, modification, and film removal operations are performed relative to a base substrate, regardless of the absolute orientation of the substrate).

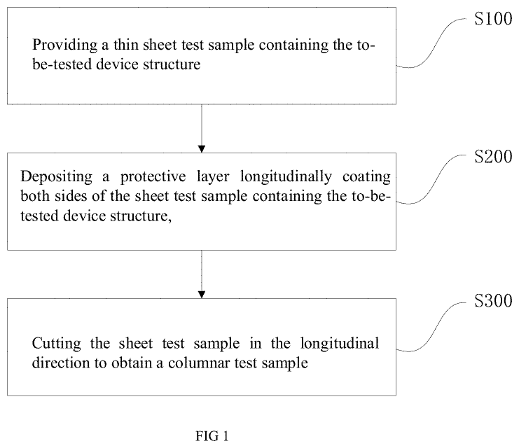

First, FIG. 1 illustrates a flowchart of the sample preparation method according to an embodiment of the present disclosure. Referring to FIG. 1, the preparation method includes the following steps: step S100: providing a sheet test sample containing the to-be-tested device structure; step S200: depositing a protective layer longitudinally coating both sides of the sheet test sample which contains the to-be-tested device structure,; and step S300: cutting the sheet test sample in the longitudinal direction to obtain a columnar test sample.

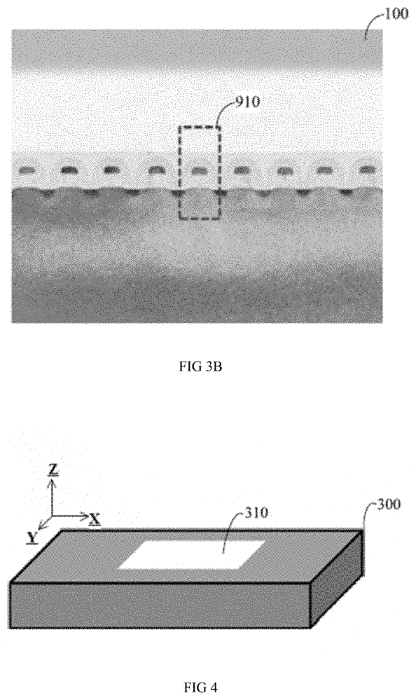

Specifically, referring to FIG. 3A and FIG. 3B which explain how the sheet test sample is formed in step S100. FIG. 3A, a first sheet test sample 100 is placed on a stage 200. FIG. 3A illustrates the first sheet test sample 100 from an X direction. The X direction is a direction perpendicular to the drawing in which the first sheet test sample 100 is observed after being placed on the stage 200. That is, an observed lateral surface (X-directional surface) of the first sheet test sample 100 exposes the first to-be-tested cross section of the target semiconductor device upward in the vertical direction. Referring to FIG. 3B, which shows a TEM image of the sheet test sample according to the embodiment. In FIG. 3B, the observed lateral surface of the first sheet test sample 100 exposes the first to-be-tested cross section 910 of the target semiconductor device in the vertical direction. In this embodiment, the perpendicular direction of the semiconductor device refers to the normal direction of a semiconductor wafer or substrate on which the semiconductor device is located.

In one embodiment, a transmission electron microscope (TEM) is used to image the first sheet test sample 100 placed as described above. In order to facilitate electrons to penetrate the sheet test sample to form a good electron diffraction image, the first sheet test sample 100 needs to be thinner than 100 nanometers.

In one embodiment, to form the first sheet test sample 100 thinner than 100 nanometers, a part of the sample can be sliced by means of a focused ion beam (FIB), so that the ultra-thin sheet sample is ready for imaging. It should be noted that a person skilled in the art maybe able to use existing or future technologies to implement specific steps of slicing a part of the sample with the focused ion beam. Those specific steps of performing slicing with the focused ion beam should not unduly limit the protection scope of the present application.

In another embodiment, it can be understood that a person skilled in the art could also use other existing or future technologies to form an ultra-thin sheet test sample for TEM imaging.

In step S200 of FIG. 1, the protective layer is deposited longitudinally on both sides of the sheet test sample containing the to-be-tested semiconductor device. By longitudinally depositing the protective layer to coat both sides of the sheet test sample, the sheet test sample becomes longer in the longitudinal direction, facilitating easier subsequent cutting to form the columnar test sample.

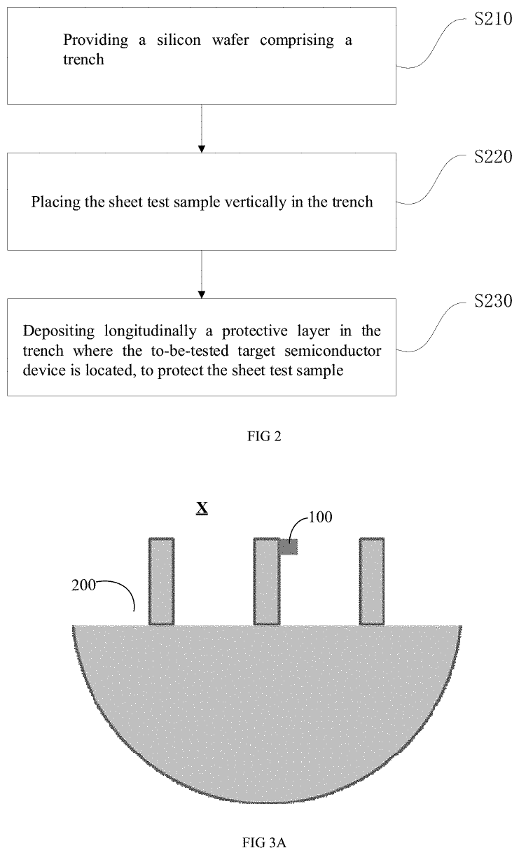

Referring to FIG. 2, which illustrates a flowchart of a method for forming the protective layer on both sides of the sheet test sample in step S200. In FIG. 2, forming the protective layer on both sides of the sheet test sample specifically includes the following steps: step S210: providing a silicon wafer having a trench; step S220: placing the sheet test sample vertically in the trench; and step S230: depositing longitudinally a protective layer in the trench where the to-be-tested target semiconductor device is located, to protect the sheet test sample.

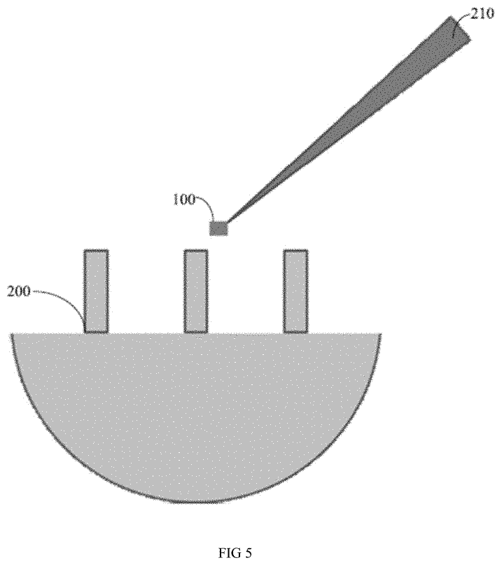

FIGS. 4, 5, 6A, 6B, 7A, 7B, 8A, and 8B explain a detailed implementation method for forming the protective layer on both sides of the sheet test sample in step S200. First, referring to FIG. 4, the trench 310 is formed in the silicon wafer 300. A person skilled in the art could form the trench in an upper portion of the silicon wafer according to an existing or a future method, which should not unduly limit the protection scope of the present application. In an embodiment, the width of the trench is configured to be slightly greater than that of the sheet test sample (greater than 1-2 micrometers), so that the sheet test sample can be successfully placed in the trench.

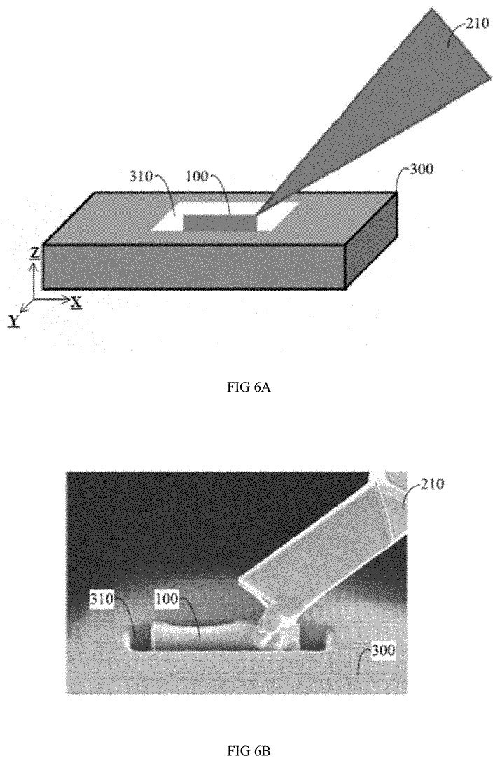

Referring to FIG. 5, the first sheet test sample 100 is taken away from the top of the pole on the stage 200 by means of the tip of a nanomanipulator 210. The sample maybe fixed to the nanomanipulator temporarily by welding the tip of the nanomanipulator to the sample, or by other means.

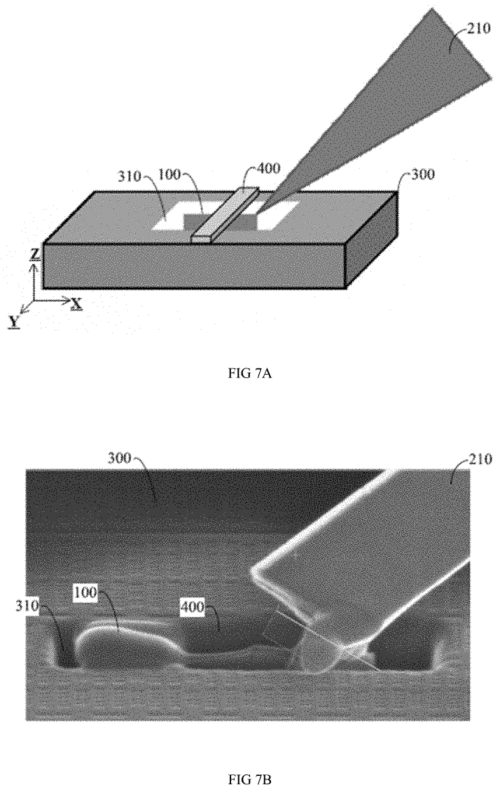

Referring to FIG. 6A, the first sheet test sample 100 is placed in the trench 310 of the silicon wafer 300 by means of the nanomanipulator 210. It should be noted that the first sheet test sample 100 is vertically placed into the trench 310 by the nanomanipulator 210, the lateral surface (X-directional surface) of the first sheet test sample 100 is in the XZ plane of the sheet sample 100 in FIG. 6A. FIG. 6B shows the TEM image of the nanomanipulator 210 placing the sheet test sample 100 in the trench 310 on the wafer 300, as illustrated in FIG. 6A.

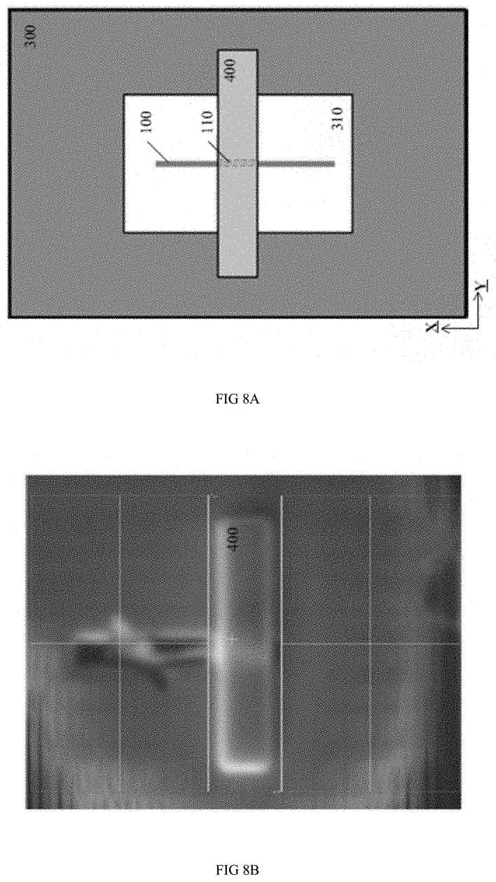

As illustrated in FIG. 7A, after the first sheet test sample 100 is placed in the trench 310, the protective layer 400 is longitudinally (along Y direction) deposited in the trench 310 to an area where the target semiconductor device is located, to longitudinally coat the first sheet test sample 100. In order to facilitate subsequent sample preparation by the focused ion beam, the deposited protective layer is also formed on both sides of the sheet test sample.

The lateral surface (in the XZ plane) of the first sheet test sample 100 exposes the first cross section of the to-be-tested semiconductor device in the vertical direction. The other cross section that needs to be imaged in the vertical direction is in the YZ plane. Therefore, a protective layer is vertically deposited in an area of the semiconductor device that needs to be imaged in the YZ plane. For example, the protective layer shown in FIG. 7A is deposited in the middle area of the first sheet test sample 100, if the imaging area of the semiconductor device is located in the middle of the first sheet test sample 100.

In the above embodiment, depositing the protective layer in the longitudinal direction refers to depositing the protective layer along the Y direction. It should be noted that a portion of the protective layer 400 is formed in the trench too to fill the gap between the first sheet test sample 100 and the trench 310, in the process of coating the lower part of the first sheet test sample 100 in the trench in the longitudinal direction. The protective layer has been formed beyond the top surface of the silicon wafer 300 as shown in FIG. 7A. FIG. 7A merely intends for a conceptual description and should not unduly limit the protection scope of the present application.

FIG. 7B shows the TEM image of the formed protective layer illustrated in FIG. 7A. It should be noted that due to various limitations of TEM imaging, a dark gray area 400 in FIG. 7B indicates the formed protective layer.

In the above embodiment, the protective layer contains metal platinum (Pt) or metal tungsten (W).

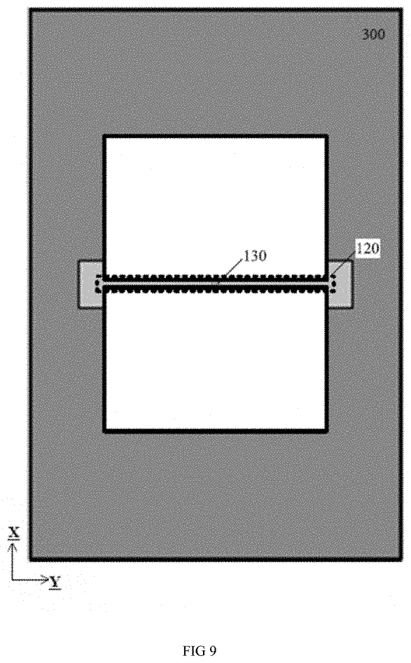

FIG. 8A illustrates relationships between the silicon wafer 300, the trench 310, the first sheet test sample 100, and the protective layer 400 in the XY plane. The above-mentioned XY plane can be construed as a top view plane. As described above, the to-be-tested semiconductor device under imaging is located on a portion of the sheet sample coated by the protective layer 400. Therefore, the imaging area is not visible in the top view of FIG. 8A, instead a dash line box 110 is drawn to indicate the longitudinally coated portion of the first sheet test sample 100. FIG. 8B shows the TEM image of the formed protective layer 400 illustrated in FIG. 8A.

After the portion of the first sheet test sample 110 that needs to be imaged is coated with the protective layer 400 in the longitudinal direction, the longitudinal width of this portion is increased. Therefore, in the subsequent step S300, the sheet test sample coated by the protective layer can be longitudinally cut to obtain the columnar test sample.

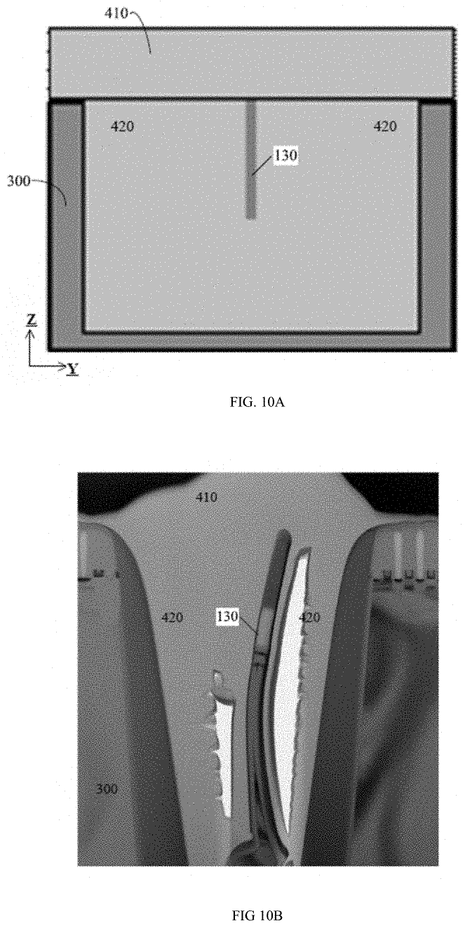

FIG. 9 illustrates a schematic diagram of longitudinally cutting the first sheet test sample coated by the protective layer. Referring to FIG. 9, after the longitudinal cutting, the formed columnar test sample 130 is still coated with the protective layer along the longitudinal direction X. Therefore, after the first sheet test sample 100 coated by the protective layer is longitudinally cut, a second sheet test sample 120 (the dashed line box in FIG. 9) coated with the columnar test sample 130 can be obtained.

In order to facilitate electrons to penetrate the sample to form a sharp electron diffraction image , the width of the columnar test sample 130 in the X direction (lateral direction) needs to be controlled to thinner than 100 nanometers.

In an embodiment, a focused ion beam is used to implement the above-mentioned longitudinal cutting. Specifically, front and rear longitudinal cutting process on the first sheet test sample 100 is performed in the X direction by a focused ion beam, so as to leave an ultra-thin sheet sample in the middle. The white rectangular box in FIG. 9 represents areas cut and removed from the sample surface by the focused ion beam.

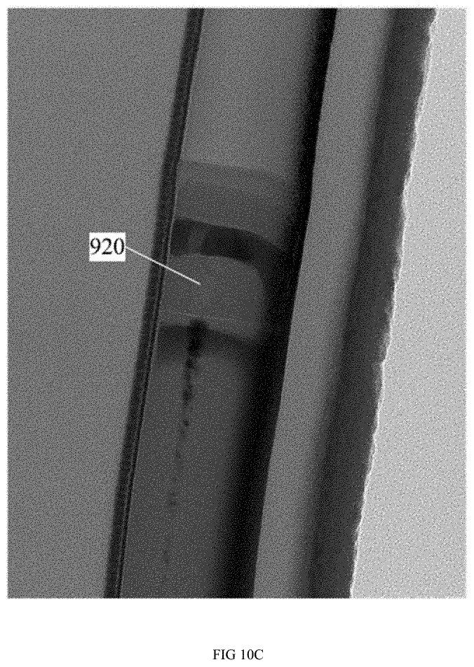

FIG. 10A illustrates a schematic diagram of the second sheet test sample 120 in the YZ plane. Referring to FIG. 10A, the second sheet test sample 120 includes the silicon wafer 300, a portion of the second protective layer 420 formed in the trench of the silicon wafer, a portion of the first protective layer 410 formed on the silicon wafer, and the columnar test sample 130 coated with the protective layer 420 in the longitudinal direction (Y direction). FIG. 10B shows the TEM image of the second sheet test sample 120 corresponding to the illustration in FIG. 10A.

It can be understood that the thickness of the columnar test sample 130 in the Y direction (longitudinal direction) is equivalent to the thickness of the first sheet test sample 100. This thickness should be less than 100 nanometers.

FIG. 10C shows the TEM image under high magnification of the columnar test sample 130 in FIG. 10B. It can be understood that the YZ plane exposes the second cross section of the target semiconductor device in the vertical direction. FIG. 10C shows the clear image of the second cross section 920 of the columnar test sample 130 under high magnification.

According to the two cross sectional views of the target semiconductor device in the vertical direction shown in FIGS. 3B and 10C, the target semiconductor device can be analyzed for improvement of the manufacturing process. In particular, the cross sectional images can be used to analyze a complex structure such as the fin field-effect transistors or can be used to analyze complex defects, thereby improving failure analysis efficiency.

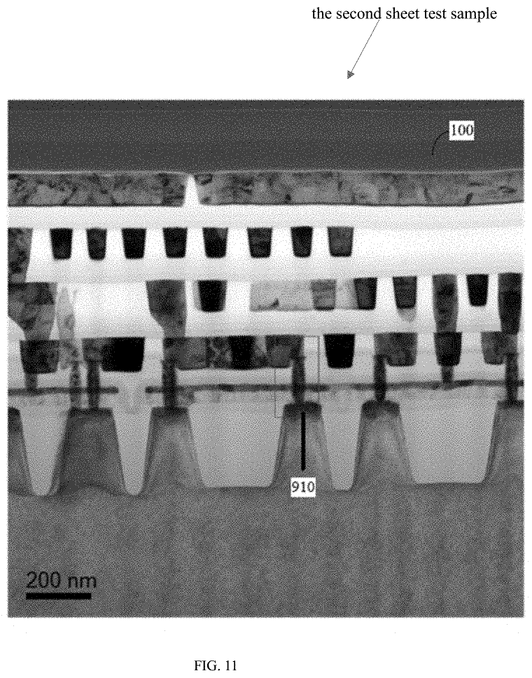

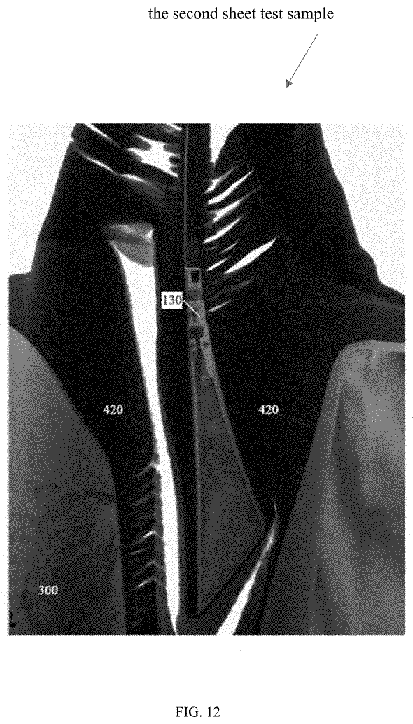

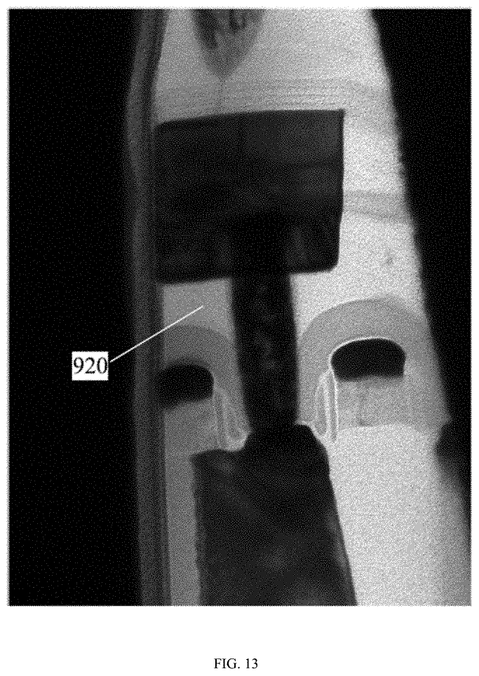

FIGS. 11-13 show TEM images from test samples prepared by other methods according to some embodiments of the present disclosure. Referring to FIG. 11, the first sheet test sample 100 exposes the first cross section 910 of the to-be-tested semiconductor device. After processing the first sheet test sample 100 according to the preparation method, the second sheet test sample is obtained, as shown in FIG. 12. Furthermore, the columnar test sample 130 that needs to be imaged is coated by the second sheet test sample. FIG. 13 further magnifies the image of the columnar test sample 130, to illustrate the second cross section 920 of the target semiconductor device.

The two cross sectional images of the target semiconductor device in the vertical direction shown in FIGS. 11 and 12 are analyzed to find defects and causes of failures, thus providing paths to improvements of process manufacturing. In particular, the cross sectional images can be used to analyze complex structures such as the fin field-effect transistors, as well as complex defects, thereby improving the TEM analysis efficiency.

The specific implementation method of for preparing test samples of semiconductor devices in the present application has been described above. According to the method, ultra-thin sample preparation includes two directions on one target semiconductor device, thus analysis of the prepared test sample can be performed in two directions by a transmission electron microscope, where structural information of the target semiconductor device viewed from two directions can be obtained, thereby improving complex structural imaging or root cause analysis of complex defects.

Although the present disclosure is described with respect to specific exemplary embodiments, it is possible that various modifications and changes can be made to these embodiments without departing from the broader spirit and scope of the present disclosure. Therefore, the specification and drawings should be construed as illustrative rather than restrictive.

It should be understood that this specification will not be used to interpret or limit the scope or meaning of the claims. In addition, in the foregoing detailed description, it can be seen that various features are combined together in a single embodiment for the purpose of simplifying the present disclosure. The method of the present disclosure should not be construed as reflecting that the claimed embodiments require more features than those explicitly listed in each claim. On the contrary, as reflected in the appended claims, the inventive subject matter includes features less than all the features of a single disclosed embodiment. Therefore, the appended claims are hereby incorporated into the detailed description, with each claim independently used as an independent embodiment.

An embodiment or embodiments mentioned in the description are intended to be included in at least one embodiment of a method in combination with the specific features, structures, or characteristics described in the embodiment. The phrase “one embodiment” in various portions of the specification does not necessarily refer to the same embodiment.

What is claimed is:

1. A method for preparing a test sample of a target semiconductor device, comprising steps of:
providing a sheet test sample, wherein the sheet test sample has a first lateral surface and a second lateral surface, wherein the first lateral surface contains the target semiconductor device, wherein the first lateral surface of the sheet test sample exposes a first cross section of the target semiconductor device in a vertical direction;
forming a protective layer on the first and second lateral surfaces of the sheet test sample, to longitudinally coat the sheet test sample; and
cutting longitudinally the sheet test sample, to obtain a columnar test sample, wherein a longitudinal surface of columnar test sample exposes a second cross section of the target semiconductor device in the vertical direction, wherein the second cross section is perpendicular to the first cross section.

2. The method for preparing a test sample according to claim 1, wherein forming the protective layer further comprises steps of:
providing a silicon wafer having a trench;
placing the sheet test sample vertically into the trench; and
depositing longitudinally a protective layer in the trench to coat the first and second lateral surfaces of the sheet test sample.

3. The method for preparing a test sample according to claim 2, wherein the protective layer is made of metal platinum (Pt) or metal tungsten (W).

4. The method for preparing a test sample according to claim 1, wherein the longitudinal cutting is performed by a focused ion beam.

5. The method for preparing a test sample according to claim 1, wherein providing the sheet test sample further comprises: cutting a wafer on which the target semiconductor device is located with a focused ion beam, to obtain the sheet test sample.

6. The method for preparing a test sample according to claim 1, wherein a longitudinal thickness of the sheet test sample is less than 100 nanometers.

7. The method for preparing a test sample according to claim 1, wherein a lateral thickness of the columnar test sample is less than 100 nanometers.

8. The method for preparing a test sample according to claim 1, wherein a longitudinal thickness of the columnar test sample is less than 100 nanometers.

9. The method for preparing a test sample according to claim 1, wherein the first lateral surface of the sheet test sample is imaged with a transmission electron microscope; and/or
wherein the longitudinal surface of the columnar test sample is imaged with a transmission electron microscope.

10. The method for preparing a test sample according to claim 1, wherein the semiconductor device is a fin field-effect transistor.
